(19) United States
(12) Patent Application Publication
(10) Pub. No.: US 2024/0392924 A1
(43) Pub. Date: Nov. 28, 2024

(54) SYSTEM FOR TREATING A NATURAL GAS COMING FROM A TANK OF A FLOATING STRUCTURE CONFIGURED TO SUPPLY NATURAL GAS AS FUEL TO A NATURAL GAS CONSUMING APPARATUS

(71) Applicant: GAZTRANSPORT ET TECHNIGAZ, Saint Remy Les Chevreuse (FR)

(72) Inventors: Bernard AOUN, Saint Remy Les Chevreuse (FR); Pavel BORISEVICH, Saint Remy Les Chevreuse (FR)

(73) Assignee: GAZTRANSPORT ET TECHNIGAZ, Saint Remy Les Chevreuse (FR)

(21) Appl. No.: 18/695,204

(22) PCT Filed: Sep. 21, 2022
(86) PCT No.: PCT/FR2022/051779

§ 371 Date: Mar. 25, 2024

(30) Foreign Application Priority Data
Sep. 30, 2021 (FR) 2110313

(51) Int. Cl. F17C 7/02

(52) U.S. Cl. CPC F17C 7/02; F17C 2221/033; F17C 2223/0153; F17C 2227/0355; F17C 2265/066; F17C 2270/0102

(57) ABSTRACT

The invention relates to a compression system (2) intended to equip a refrigerant circuit (4), comprising at least one compression device (19) configured to compress the refrigerant, the compression device (19) comprising at least one compression member (10) actuated by a drive device (32), which are connected together by at least one bearing (14) configured to be at least partially sealed by the refrigerant, the compression system (2) comprising a device (22) for collecting the refrigerant present in the drive device (32), the device (22) for collecting refrigerant being configured to send the refrigerant collected from the drive device (32) to the refrigerant circuit (4).

The present invention relates to the field of compression systems designed for installation of floating structures using, storing and/or transporting liquefied natural gas. It notably relates to a system of treatment of natural gas as a fuel for at least one natural gas consuming apparatus that equips the floating structure.

To transport long distance and/or store natural gas more easily, the natural gas is usually maintained under liquid state at temperatures lower than −163° C. under ambient pressure, in order to get liquefied gas, usually called “GNL” or “LNG” (liquefied natural gas). This liquefied natural gas is then loaded to or unloaded from dedicated storage tanks on the floating structure.

Such tanks are never perfectly thermally isolated; hence, the natural gas at least partly evaporates. Thus, these tanks contain natural gas both as a liquid and as a gas. This latter form of natural gas is also called “BOG” (boil-off gas) and builds up in the tank blanket.

It is known that at least a part of the vapor-state natural gas in the tank can be used to feed a consuming apparatus, such as a motor, provided to cope with the power requirements of the floating apparatus, in particular for its propulsion and/or its electricity production for the equipment aboard. To do so, in particular, it is known to have the vapor-state natural gas circulate through at least a natural gas treatment system to allow its compression and heating up to a temperature suitable for use as a fuel in the consuming apparatus. Such a treatment system comprises a coolant circuit configured to implement at least a heat exchange between the natural gas that flows through the treatment system.

The known coolant circuit implements a compression device. Since such a circuit works at cryogenic temperatures, it is compulsory that the watertightness of the various rotation bearings of the compression device is made thanks to a gas, for example dinitrogen. Indeed, at such temperatures, using some oil in the compression device(s) is accompanied with the solidification of at least a part of the oil, which may spoil the function of the treatment system. A drawback of using a compression device from a dinitrogen-sealed bearing is the unavoidable leaks of dinitrogen into the coolant that flows through the circuit, which leads to an altering of the reference composition of said coolant, hence a reduction of the performances of the coolant circuit.

The invention corrects this defect and proposes a compression system designed to equip a coolant circuit, comprising at least a compression device configured to compress the coolant, wherein the compression device comprises at least a compression mechanism driven by a driving device, which are connected together by at least one bearing configured to be at least partly sealed by the coolant, wherein the compression system comprises a recycling device for the coolant in the driving device, with the coolant recycling device configured to return the recycled coolant through the driving device to the coolant circuit.

In the present invention, the compression device comprises a compression mechanism driven by a driving device, which are connected together by at least one bearing configured to be at least partly sealed by the coolant. The integrity of the coolant in the coolant circuit is preserved, since the gas that seals the bearing is the coolant itself, and since it is recycled back into the coolant circuit. Since the watertightness of the bearing is guaranteed by the coolant, the coolant circuit is not polluted by unwanted gas and the flowing mass of coolant through the coolant circuit is maintained.

Since the bearing is configured to be at least sealed by the coolant, a part of the bearing can have no sealing system, while another part is sealed by the coolant, which means by a fluid identical to the one compressed by the compression mechanism, when the compression system is mounted on the coolant circuit. The watertightness at the part of the bearing configured for sealing by the coolant is provided by the coolant only. Thus, it does not call for any other gas.

That way, the recycling device makes it possible to suck the coolant from the gear box of the driving device through a compression device, and then to separate it from the lubricant that comes from the gear box thanks to a filtration mechanism, for example.

According to a characteristic of the invention, the recycling device comprises at least one compression mechanism and at least a pipe, on which the compression mechanism is positioned, wherein the pipe extends from the driving device to an injection point that is configured for positioning on a low-pressure part of the coolant circuit.

The recycling device comprises a compression mechanism, for example as a diaphragm compressor, and a pipe located between the gear box and the injection point on the coolant loop.

According to another characteristic of the invention, the recycling device comprises at least one filtration mechanism. The filtration mechanism captures the lubricant from the pipe before introduction of the coolant into the coolant circuit. The filtration mechanism can be positioned upstream from the compression mechanism to remove the lubricant before it enters the compression mechanism. In those conditions, the compression mechanism receives gas recovered from the gear box with its lubricant content removed.

Alternatively, the filtration mechanism can be located downstream from the compression mechanism.

According to another characteristic of the invention, the driving device comprises a gear box and an actuator that rotatively drives at least one gear of the gear box, wherein the recycling device is in fluidic communication with an upper part of the gear box. The actuator rotates a plurality of the gears that constitute the gear box. For example, the actuator can be electric, pneumatic or hydraulic. According to a preferential example, the actuator is an electric motor.

The recycling device is connected to the upper part of the gear box, in order to guarantee the recovery of the coolant as a gas, wherein the gas-phase coolant builds up in the upper part of the gear box. The position of the recycling device relatively to the gear box also makes it possible to reduce the amount of lubricant that the recycling device captures.

According to a characteristic of the invention, the compression system comprises a pipe connected to the bearing and configured for fluidic communication to a high-pressure part of the coolant circuit. The pipe connected to the bearing makes it possible to provide coolant under high pressure in order to seal the rotation bearing between the gear box and the compression device.

According to another aspect, the invention relates to a coolant circuit comprising at least two heat exchangers, an expansion device and a compression system as described in the present document.

Advantageously, the coolant in the coolant circuit contains:
20 to 35% mol of dinitrogen or 30 to 50% mol of argon or 35 to 50% mol of a mix of dinitrogen and argon, and
35 to 55% mol of methane,
   wherein said coolant contains a part of methane and dinitrogen and/or argon between 70 and 85% mol of the coolant, with the rest comprising a mix of hydrocarbons made of at least ethane and/or propane and/or butane and/or ethylene and/or propylene. Such a composition of the coolant is particularly suitable for a heat exchange with natural gas used as a fuel to feed a consuming apparatus of a natural gas treatment system on a floating structure.

According to a characteristic of this invention, the injection point is positioned on the coolant circuit between an outlet of the expansion device and an inlet of the compression mechanism, which delineates the low-pressure part of the coolant circuit. The high-pressure part of the coolant circuit starts at the outlet of the compression mechanism and ends at the inlet of the expansion device.

According to a characteristic of the invention, the pipe is connected to the coolant circuit at a point located between the outlet of the compression mechanism and the inlet of the expansion device, whereby constituting the high-pressure part of the coolant circuit.

The pipe makes it possible to receive the coolant into the bearing between the compression mechanism and the gear box. This pipe is fed by the high-pressure part of the coolant circuit.

According to another aspect, the invention relates to a system for treatment of natural gas stored in a floating structure, comprising at least a tank designed for transporting and/or storing liquid-state natural gas, a supply system designed to provide natural gas to a consuming device of the floating structure and a coolant circuit as described in the present document.

According to a characteristic of this invention, the treating system comprises at least one consuming apparatus of natural gas as a fuel. This consuming apparatus uses natural gas as a fuel that flows through the supply system from the tank.

The natural gas in the blanket of the tank flows into the first heat exchanger, which makes it possible to warm it up when the coolant circuit is working. Then, this warmed-up gas flows into a compression mechanism to increase the pressure and the temperature of the vapor-state natural gas. Then, the natural gas is used as a fuel for the consuming apparatus of the floating structure.

Other characteristics, details and advantages of the invention will appear more obviously thanks to the following description, on one hand, and thanks to several embodiments produced as a guide and non-limitative with a reference to the appended schematic pictures, on the other hand, where:

FIG. 1 shows the compression mechanism according to the invention;

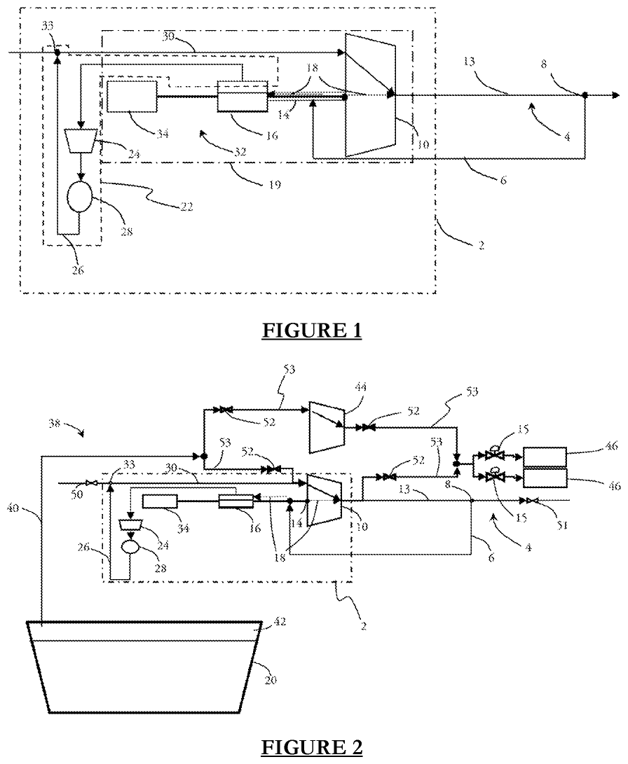

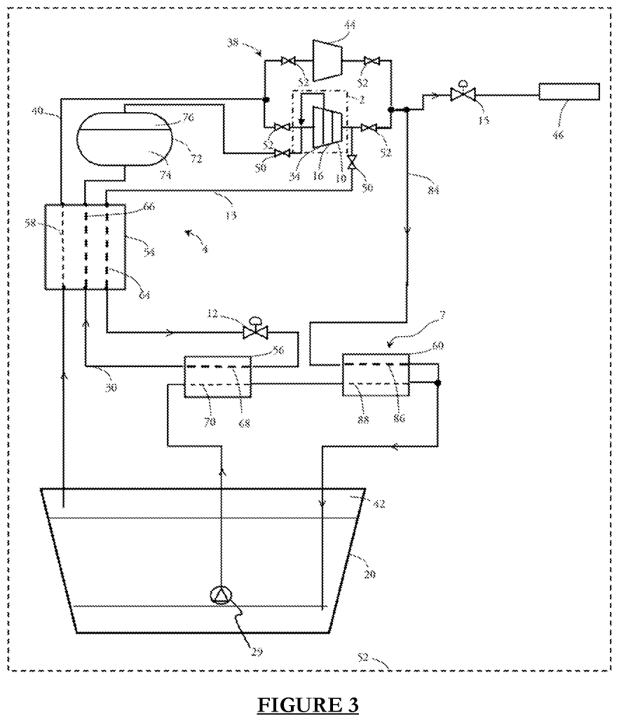

FIG. 2 is a schematic view of the compression system according to the invention integrated in a natural gas supply system;

FIG. 3 is a schematic view of a treatment system for liquefied natural gas that is stored in a tank of a floating structure for transporting and/or storing said natural gas;

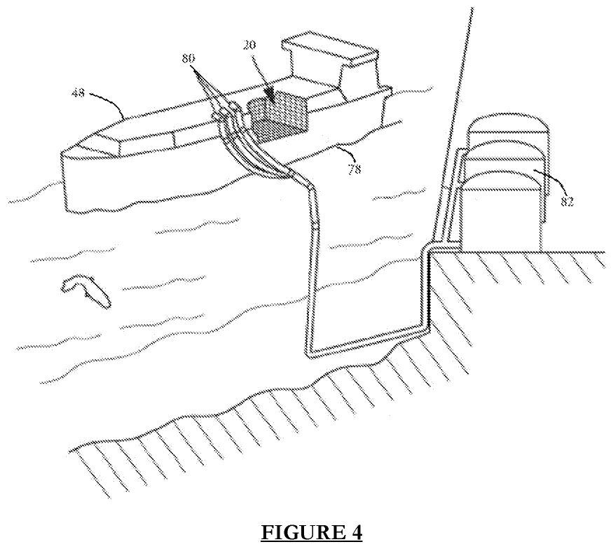

FIG. 4 is a schematic broken-open view of the tank of a floating structure and of a loading and/or unloading terminal for this tank.

FIG. 1 shows a compression mechanism 2 configured to compress the coolant in the coolant circuit 4. The coolant circuit 4 comprises two parts: a high-pressure part 13 and a low-pressure part 30. The low-pressure part 30 is a part of the coolant circuit upstream from the compression system 2, while the high-pressure part 13 is located downstream from the compression system 2, following the direction of flow of the coolant through the coolant circuit.

This compression system 2 comprises at least a compression device 19, whose function is to compress the coolant. The compression device 19 comprises a compression mechanism 10 and a driving device 32, whose function is to drive, in particular to rotate, the compression mechanism 10. The compression mechanism 10 is a part of the compression device 19 that operates the compression. In particular, it can be a centrifugal compressor, a screw compressor or a piston compressor.

The driving device 32 is a set that comprises a actuator 34, in particular an electric, pneumatic or hydraulic motor, and a gear box 16 that is kinematically mounted between the actuator 34 and the compression mechanism 10. The function of the gear box 16 is to adapt the torque and the speed between the actuator 34 and the compression mechanism 10. Such a gear box 16 comprises a box with a plurality of gears and shafts that turn inside.

A first of these shafts is positioned between the actuator 34 and an input gear of the gear box 16. Another shaft is an output shaft that extends from the inside of the carter of the gear box until the inside of the compression mechanism 10.

A bearing 14 is located between the gear box 16 and the compression mechanism 10, and this bearing 14 constitutes the item that rotatively carries the output shaft of the gear box 16. The watertightness of such a bearing 14 is made by injection of the coolant from the coolant circuit 4 into the bearing 14 at a pressure higher than the one at the inlet of the compression mechanism 10.

To do so, the compression system 2 comprises a pipe 6 that extends between the bearing 14 and a point 8 located on the coolant circuit 4 downstream from the compression mechanism 10 and in the high-pressure part of this circuit. The pipe 6 is configured to channel some coolant from the coolant circuit toward the bearing 14. The latter is however not totally watertight and a first fraction of the coolant spreads into the compression mechanism 10 while a second fraction of the coolant flows to the gear box 16 and fills it. These fractions of coolant are pictured as a dotted arrow 18 in FIG. 1.

The compression system 2 according to the invention also comprises a coolant recycling device 22 present in the driving device 32, in particular present in the gear box 16, because of the fraction 18 of the coolant that flows through the bearing 14 and into the gear box 16. The function of the recycling device 22 is to capture the coolant from the gear box 16 and to return it into the coolant circuit in order to maintain a circulating mass of coolant through the coolant circuit 4 in conformity with the original requirements.

The recycling device 22 extends from the gear box 16 to an injection point 33 located on the cooling circuit 4 in the low-pressure part 30 of this circuit.

The recycling device 22 is connected to an upper part of the gear box 16 in order to recover the vapor-state coolant. The coolant in the gear box 16 flows through a pipe 26 that, at one end, is connected to the upper part of the carter of the gear box 16 and, at the other end, is connected to the coolant circuit 4 upstream from the compression mechanism 10 at the injection point 33.

The recycling device 22 comprises a compression mechanism 24 that can, for example, be a diaphragm compressor. The compression mechanism 24 is configured to extract the coolant from the gear box 16 and to return it to the low-pressure part of the coolant circuit 4. That's the way this compression mechanism 24 increases the pressure of the recovered coolant in the gear box 16 above the pressure of the coolant in the coolant circuit upstream from the compression mechanism 10, which means in the low-pressure part of this circuit.

Facultatively, the recycling device 22 comprises a filtration mechanism 28 that can be positioned on the pipe 26 upstream or downstream from the compression mechanism 24 in reference with the flowing direction of the coolant through the pipe 26.

When the filtration mechanism 28 is laid out upstream from the compression mechanism 24, this means separating the lubricant of the gear box 16 from the coolant before this coolant flows into the compression mechanism 24. In another case of use, the filtration mechanism 28 is located downstream from the compression mechanism 24. The vapor-state coolant and the lubricant are then separated by the filtration mechanism 28, so that only the coolant is returned to the coolant circuit 4, which means lubricant-free.

FIG. 2 shows a fuel supply system 38 for consuming apparatuses 46 mounted on a floating structure that is equipped with such a supply system 38. Here, the fuel is liquefied natural gas that is stored in a tank 20 mounted on the floating structure. This supply system 38 comprises the compression system as described in FIG. 1.

Thus, the supply system 38 comprises at least one tank 20 designed to contain liquefied natural gas and an input circuit 40 configured to recover the vapor-state natural gas in the blanket 42 of the tank 20 and to provide it to at least one consuming apparatus 46. This natural gas in the blanket 42 of the tank 20 results from the natural evaporation of the natural gas that is stored under liquid state in the tank 20.

The input circuit 40 comprises a compressor 44 configured to increase the temperature and the pressure of the vapor-state natural gas, in order to put this natural gas under pressure and temperature conditions compatible with the need of the at least one fuel consuming apparatus 46 on the floating structure. As an example, at least one fuel consuming apparatus 46 can be an electric DFDE-type (Dual Fuel Diesel Electric) motor-generator, which means a gas-consuming apparatus configured to power the floating structure or a propelling motor of the ship, such as a ME-GI or XDF motor. It shall be understood that this is only an embodiment of the present invention, and that different gas-consuming apparatuses can be set up without leaving the scope of the present invention.

The compressor 44 is redundant with the compression mechanism 10, such that the latter can compensate for a breakdown of the compressor 44 to keep the gas supply of the at least one consuming apparatus 46 operational, in particular the propelling motor of the ship.

Such a redundancy also results in the use of valves, such as a first shut-down valve 50 located on the low-pressure part 30 of the coolant circuit 4. This first shut-down valve 50 is configured to block the input of the coolant into the compression mechanism 10. Similarly, the coolant circuit comprises a second shut-down valve 51 on the high-pressure part 13 of the coolant circuit 4, whose function is to isolate the compression mechanism 10 from the rest of the coolant circuit when it is used in the input circuit 40, which means to provide fuel the at least one consuming apparatus 46 of the floating structure.

The input circuit 40 also comprises valves 52 downstream and upstream from a group made of the compressor 44 and the compression mechanism 10. These valves 52 are configured to manage the gas feeding from the blanket 42 of the tank 20 either to the compressor 44 or to the compression mechanism 10, so that the compressor 44 is assigned to the input circuit 40, while the compression mechanism 10 is assigned to the coolant circuit 4. These valves 52 and pipes 53 make it possible to use the compression mechanism 10 in the input circuit 40 when the compressor 44 is faulty, as mentioned above.

The input circuit 40 also comprises at least one expansion device 15, whose function is to adapt the pressure of the gas sent to the consuming apparatus 46 by reducing it.

FIG. 3 shows a system for treatment of natural gas 52 that is stored under liquid state in the tank 20 of a floating structure 48 for transporting and/or storing natural gas, such as schematically pictured in FIG. 4.

The natural gas treatment system 52 comprises the supply system 38 as described in FIG. 2 and a compression system 2 according to the invention. FIG. 3 shows in details the design of the coolant circuit 4, including such a compression system 2 and the interaction between the coolant circuit 4 and the input circuit 40, or the interaction between the coolant circuit 4 and at least a natural gas liquefaction plant 7.

Thus, the coolant circuit 4 comprises at least one compression mechanism 10 as described above, a first heat exchanger 54, an expansion device 12, for example a Joule-Thomson valve, and a second heat exchanger 56.

The coolant that flows through the coolant circuit has the following composition: 20 to 35% mol of dinitrogen or 30 to 50% mol of argon or 35 to 50% mol of a mix of dinitrogen and argon and 35 to 55% mol of methane, wherein this coolant contains a part of methane and dinitrogen and/or argon between 70 and 85% mol of the coolant, with the rest comprising a mix of hydrocarbons made of at least ethane and/or propane and/or butane and/or ethylene and/or propylene. This composition makes it possible for the coolant to change of state at temperatures that the natural gas can have in the treatment device.

Examples of composition of this coolant and proportions of its components can have the following formulas:

TABLE 1

| Components (% mol) | 1 | 2 | 3 | 4 | 5 |
|---|---|---|---|---|---|
| N₂ | 30 | 32 | 32 | 0 | 20 |
| Ar | 0 | 0 | 0 | 46 | 30 |
| Methane (C1) | 45 | 44 | 40 | 35 | 35 |
| Ethane (C2) | 10 | 12 | 10 | 9 | 8 |
| Propane (C3) | 15 | 0 | 9 | 0 | 7 |
| Butane (C4) | 0 | 12 | 9 | 10 | 0 |

According to the needs of vapor-state natural gas of the fuel consuming apparatuses 46, the natural gas liquefaction unit 7 provides for the liquefaction of at least a part of the natural gas from the tank 20 and that is not consumed by the consuming apparatus 46.

On the other hand, the second heat exchanger 56 provides for the evaporation of the coolant in the coolant circuit 4. This second heat exchanger 56 also provides a subcooling of the liquid-state natural gas, in order to make easier the liquefaction of the natural gas that flows through the liquefaction unit 7, wherein a part of the subcooled liquid-state natural gas is returned to the liquefaction unit 7 to cool the vapor-state natural gas flowing through the return pipe 84.

In the natural gas treatment system 52, the coolant circuit 4 is made of an unit able to exchange calories with the liquid-state or vapor-state natural gas.

In particular, in the present invention, the liquid-state natural gas has a liquefaction temperature at room temperature of ca. −163° C. The composition of the coolant flowing through the coolant circuit 4 is suitable for this temperature, in order to optimize the efficiency of the heat exchanges that happen at a cryogenic temperature between the coolant and a liquid-state or vapor-state natural gas from the tank 20.

As described above, the coolant is first compressed by the compression mechanism 10, then flows through the high-pressure part 13 of the coolant circuit 4 until a first channel 64 through the first heat exchanger 54.

Then, the first heat exchanger 54 comprises at least three channels: the coolant under high pressure flows through the first channel 64, the coolant under low pressure flows through the second channel 66, and the vapor-state natural gas from the blanket 42 of the tank 20 flows through the third channel 58 of the first heat exchanger 54.

The first heat exchanger 54 works as a condenser. This first heat exchanger 54 makes it possible to reduce the temperature of the coolant in the high-pressure part 13 before it flows into the expansion device 12. This temperature reduction takes place by heat exchange between the coolant that flows through the first channel 64 and the third channel 58 of the first heat exchanger 54, wherein this latter channel is traveled by vapor-state natural gas resulting from the natural evaporation of the liquid part of the natural gas that is stored in the tank 20.

The first heat exchanger 54 is facultatively configured to work, at least partly, as an internal heat exchanger that implements an exchange of heat between the high-pressure part 13 of the coolant circuit 4 and the low-pressure part 30 of the coolant circuit 4. The coolant in the first channel 64 of the first heat exchanger 54 captures the cold from the coolant of the second channel 66 and cold from the vapor-state natural gas from the blanket 42 of the tank 20.

At the outlet of the first channel 64 of the first heat exchanger 54, the coolant circuit 4 reaches the expansion device 12, where the coolant is expanded and its pressure is so reduced, that its temperature falls between −168 and −180° C.

Then, the coolant circuit 4 reaches a first channel 68 of the second heat exchanger 56 that exchanges calories with a second channel 70 of the second heat exchanger 56, wherethrough liquid-state liquefied natural gas flows at a temperature of ca. −163° C. thanks to a pump 29. Since the natural gas has a temperature higher than the coolant, it yields calories to the coolant, hence it captures some cold. The coolant flows out of the first channel 68 of the second heat exchanger 56 under vapor state at a temperature of ca. −162° C., while the liquid-state natural gas is subcooled at a temperature of ca. −172° C. as measured at the outlet of the second channel 70 of the second heat exchanger 56. In this situation, the second heat exchanger 56 works as an evaporator.

Then, the coolant circuit 4 reaches the second channel 66 of the first heat exchanger 54 where, as previously explained, the coolant captures the calories from the coolant that flows through the first channel 64 of the first heat exchanger 54.

Thus, the coolant flows out of the second channel 66 of the first heat exchanger 54 under a substantially vapor state. Then, the coolant is at a temperature between −30° C. and 45° C. and flows toward the compression mechanism 10.

Advantageously, the coolant circuit 4 can comprise at least one build-up device 72. The latter, located between the second channel 66 of the first heat exchanger 54 and the inlet of the compression mechanism 10, is configured to be a build-up zone for the coolant under a biphasic state 74 or under vapor state 76, and to send only vapor-state coolant 76 to the compression mechanism 10.

The vapor-state natural gas compressed by the compressor 44 can be returned to the tank 20 via a return pipe 84. The return pipe 84 carries the vapor-state natural gas to the liquefaction unit 7, the latter comprising a heat exchanger 60, whose function is to cool the vapor-state natural gas in order to liquefy it before it returns to the tank 20. To do so, this heat exchanger 60 comprises a first channel 86 that the vapor-state natural gas flows from the input circuit 40, which operates heat exchanges with a second channel 88 that liquid-state natural gas flows after cooling by the second heat exchanger 56. So, the vapor-state natural gas returns to liquid state and is returned to the tank 20.

At last, FIG. 4 is a broken-open view of a floating structure 48 that can embark the compression system 2 according to the invention, alone or in combination with the supply system 38 such as described in FIG. 2, or integrated to a system for treatment of natural gas 52 as described in FIG. 3.

The floating structure 48 comprises the natural gas storage tank 20 mounted in a hull 78 of the floating structure 48, wherein this tank 20 is made of a set of at least one primary waterproofing membrane, a secondary waterproofing membrane and two thermally isolating barriers respectively positioned between the primary waterproofing membrane and the secondary waterproofing membrane and between the secondary waterproofing membrane and the hull.

Loading and/or unloading pipes 80 located on the upper deck of the floating structure 48 can be connected thanks to suitable connectors to a maritime or port terminal 82 to transfer the liquid-state natural gas cargo from or to the tank 20.

It shall be understood from the above that the present invention proposes a compression system 2 with bearings that are sealed by the coolant. The leak from this sealing is recovered to the gear box and then returned to the coolant circuit. This compression system is integrated to a supply system of a consuming apparatus, and more generally, to a natural gas treatment system that equips a ship.

The present invention cannot be limited to the means and configurations described and illustrated here and must also include any equivalent means and configuration and any technically effective combination of such means. In particular, the number of heat exchangers can be modified, wherein the first heat exchanger can be divided in a plurality of heat exchangers, as far as the treatment system eventually fulfills the same functions as described in this document.

1. A compression system designed to equip a coolant circuit, comprising at least a compression device configured to compress the coolant, wherein the compression device comprises at least a compression mechanism driven by a driving device, which are connected together by at least one bearing configured to be at least partly sealed by the coolant, wherein the compression system comprises a recycling device for the coolant in the driving device, with the coolant recycling device configured to return the recycled coolant through the driving device to the coolant circuit.

2. The compression system according to claim 1, wherein the recycling device comprises at least one compression mechanism and at least a pipe, on which the compression mechanism is positioned, wherein the pipe extends from the driving device to an injection point that is configured for positioning on a low-pressure part of the coolant circuit.

3. The compression system according to claim 1, wherein the recycling device comprises at least one filtration mechanism.

4. The compression system according to claim 1, wherein the driving device comprises a gear box and an actuator that rotatively drives at least one gear of the gear box, wherein the recycling device is in fluidic communication with an upper part of the gear box.

5. The compression system according to claim 1, which comprises a pipe connected to the bearing and configured for fluidic communication to a high-pressure part of the coolant circuit.

6. A coolant circuit comprising at least two heat exchangers, an expansion device and a compression system according to claim 1.

7. The coolant circuit according to claim 6, comprising a coolant that contains:
20 to 35% mol of dinitrogen or 30 to 50% mol of argon or 35 to 50% mol of a mix of dinitrogen and argon, and
35 to 55% mol of methane,
wherein said coolant contains a part of methane and dinitrogen and/or argon between 70 and 85% mol of the coolant, with the rest comprising a mix of hydrocarbons made of at least ethane and/or propane and/or butane and/or ethylene and/or propylene.

8. The coolant circuit according to 6,
wherein the recycling device comprises at least one compression mechanism and at least a pipe, on which the compression mechanism is positioned, wherein the pipe extends from the driving device to an injection point that is configured for positioning on a low-pressure part of the coolant circuit, and
wherein the injection point is positioned on the coolant circuit between an outlet of the expansion device and an inlet of the compression mechanism, which delineates the low-pressure part of the coolant circuit.

9. A coolant circuit according to claim 6 further comprising:
a pipe connected to the bearing and configured for fluidic communication to a high-pressure part of the coolant circuit,
wherein the pipe is connected to the coolant circuit at a point located between an outlet of the compression mechanism and an inlet of the expansion device, which constitutes the high-pressure part of the coolant circuit.

10. The system for treatment of natural gas stored in a floating structure, comprising at least a tank designed for transporting and/or storing liquid-state natural gas, a supply system designed to feed natural gas to a consuming apparatus of the floating structure and a coolant circuit according to claim 6.

11. The system for treatment of natural gas according to claim 10, comprising at least one consuming apparatus of natural gas as a fuel.
